(19) United States
(12) Patent Application Publication
(10) Pub. No.: US 2022/0362741 A1
(43) Pub. Date: Nov. 17, 2022

(54) HYDROLYTICALLY STABLE ZWITTERIONIC CHROMATOGRAPHIC MATERIALS

(71) Applicant: Waters Technologies Corporation, Milford, MA (US)

(72) Inventors: Nicole L. Lawrence, Stafford Springs, CT (US); Darryl W. Brousmiche, Grafton, MA (US); Jessica Field, Webster, MA (US); Daniel P. Walsh, Danvers, MA (US)

(73) Assignee: Waters Technologies Corporation, Milford, MA (US)

(21) Appl. No.: 17/731,952

(22) Filed: Apr. 28, 2022

Related U.S. Application Data
(60) Provisional application No. 63/181,714, filed on Apr. 29, 2021.

(51) Int. Cl. B01J 20/26; B01D 15/36; B01J 20/28; B01J 43/00

(52) U.S. Cl. CPC B01J 20/262; B01D 15/364; B01J 20/28083; B01J 20/28085; B01J 43/00

(57) ABSTRACT

In some aspects, the present disclosure pertains to chromatographic materials that comprise (a) a bulk material and (b) a zwitterionic polymer covalently linked to a surface of the bulk material, in which the zwitterionic polymer comprises one or more monomer residues that comprise an amide or urea moiety, a positively charged moiety, and a negatively charged moiety. Other aspects of the present disclosure pertain to chromatographic separation devices that comprise such chromatographic materials, to chromatographic methods that employ such chromatographic separation devices, and to kits that contain (i) such chromatographic materials and (ii) one or more chromatographic devices for containing such materials.

### CROSS-REFERENCE TO RELATED APPLICATIONS

This application claims priority to and the benefit of U.S. Provisional Application Ser. No. 63/181,714, filed Apr. 29, 2021, and entitled “Hydrolytically Stable Zwitterionic Chromatographic Materials.” The foregoing application is incorporated herein by reference in its entirety.

### FIELD OF THE INVENTION

The present disclosure is directed to zwitterionic chromatographic materials and their use in liquid chromatography, including liquid chromatography/mass spectroscopy applications.

### BACKGROUND

Chromatographic columns containing zwitterionic stationary phases are used to separate polar analytes via liquid chromatography (LC), and particularly via hydrophilic interaction liquid chromatography (HILIC), due to their ability to provide increased analyte retention. These stationary phases have surface zwitterions, which comprise positively and negatively charged moieties in offsetting numbers, such that there is no net charge associated with the stationary phases. A common drawback of these commercially available columns is that the stationary phases bleed particular species during LC that are easily detectable in mass spectroscopy (MS). This stationary phase bleed makes it difficult to identify analytes of similar mass and decreases overall sensitivity, making accurate quantification challenging and detection of compounds in low concentrations problematic. Another common complaint associated with zwitterionic phases is that stationary phase bleed can lead to irreproducible chromatographic results over time.

The present inventors hypothesized that stationary phase bleed associated with commercially available columns is at least partially due to hydrolyzed zwitterionic monomer residues that are released from the surface of the stationary phase of commercially available LC columns, which may be due to hydrolysis of zwitterionic polymers attached to the stationary phase material or hydrolysis of zwitterionic monomers that may be adsorbed to and/or entrapped in the stationary phase material. The stationary phase bleed, which is evident at 212 m/z+ during positive mode MS and correlates to a portion of a zwitterionic monomer residue that has been cleaved at an ester moiety, which is a hydrolytically unstable functional group present in commercially available zwitterionic phases.

### SUMMARY

In the present disclosure, a novel chromatographic material is provided that includes a bulk material and a covalently linked zwitterionic polymer comprising one or more zwitterionic monomer residues in which the zwitterionic monomer residues do not contain hydrolytically unstable ester moieties. Instead, in the chromatographic materials of the present disclosure comprise monomer residues that contain moieties having improved hydrolytic stability relative to ester moieties, such as alkyl, amide and urea moieties, among others. As detailed in the Examples below, using this strategy in conjunction with an amide linkage, the present inventors were able to eliminate stationary phase bleed observed at 212 m/z+ and to reduce overall stationary phase bleed as well.

As used herein a monomer “residue” can refer to the residual portion of a monomer that is covalently incorporated by polymerization and/or to a residual unreacted monomer that remains associated with a chromatographic material due to, for example, adsorption and/or entrapment.

As used herein stationary phase “bleed” is defined as chemical species that are removed from the stationary phase during chromatographic separation processes that precede further analysis, including mass spectroscopy analysis

In certain embodiments, to further increase stability, novel chromatographic materials are provided in which the bulk material to which the zwitterionic polymer is bonded is a hybrid inorganic-organic bulk material, which provides improved stability over a wide pH range when compared with silica bulk material and which affords increased rigidity and efficiency when compared to polymer based particles.

According to an aspect of the present disclosure, chromatographic materials are provided, which comprise (a) a bulk material and (b) a zwitterionic polymer that comprises one or more zwitterionic monomer residues covalently linked to a surface of the bulk material, in which the zwitterionic monomer residues comprise an amide or urea moiety, a positively charged moiety and a negatively charged moiety.

In some embodiments, the amide or urea moiety, the positively charged moiety and the negatively charged moiety are separated from one another by C₁-C₁₂ alkyl groups.

In some embodiments which can be used in conjunction with any of the above aspects and embodiments, the positively charged moiety is a quaternary ammonium moiety and the negatively charged moiety is a surface moiety, a sulfonate moiety, a or a phosphate moiety.

In some embodiments which can be used in conjunction with any of the above aspects and embodiments, the zwitterionic polymer comprises one or more zwitterionic monomer residues that comprise a sulfobetaine moiety containing an amide linkage or a urea linkage.

In some embodiments which can be used in conjunction with any of the above aspects and embodiments, the zwitterionic polymer comprises one or more di-C₁-C₅-alkyl(methacryloylamino-C₁-C₁₂-alkyl) ammonium C₁-C₁₂-alkane sulfonate residues. In certain of these embodiments, the zwitterionic polymer comprises one or more dimethyl(methacryloylaminopropyl) ammonium propane sulfonate residues.

In some embodiments which can be used in conjunction with any of the above aspects and embodiments, the one or more zwitterionic monomer residues of the zwitterionic polymer is covalently linked to the surface of the bulk material through a residue of an organosilane monomer that is able to participate in radical polymerization and form the zwitterionic polymer.

In some embodiments which can be used in conjunction with any of the above aspects and embodiments, the zwitterionic species that comprise one or more zwitterionic monomer residues is covalently linked to the surface of the bulk material through a residue of an alkenyl-functionalized organosilane monomer. In certain of these embodiments, the alkenyl-functionalized organosilane monomer may be selected from 3-methacryloxypropyltrimethoxysilane (MAPTMOS), methacryloxypropyltrichlorosilane, 3-methacryloxypropyltriethoxysilane, vinyltriethoxysilane (VTES), vinyltrimethoxy silane, N-(3-acryloxy-2-hydroxypropyl)-3-aminopropyltriethoxysilane, (3-acryloxypropyl)trimethoxysilane, O-(methacryloxyethyl)-N-(triethoxysilylpropyl)urethane, N-(3-methacryl oxy-2-hydroxypropyl)-3-aminopropyltricthoxysilane, methacryloxymethyltriethoxysilane, methacryloxymethyltrimethoxysilane, methacryloxypropylmethyldiethoxysilane, methacryloxypropylmethyldimethoxysilane, methacryloxypropyltris(methoxyethoxy)silane, or 3-(N-styrylmethyl-2-aminoethylamino)propyltrimethoxysilane hydrochloride, among others.

In some embodiments which can be used in conjunction with any of the above aspects and embodiments, the bulk material is a porous or a superficially porous material. In certain of these embodiments, the porous or superficially porous material has a surface pore size ranging from 45 to 3000 Å.

In some embodiments which can be used in conjunction with any of the above aspects and embodiments, the bulk material is a monolithic material or a particulate material Wherein the bulk material is a particulate material, the particulate material may have a particle size ranging from 0.3 to 100 μm, among other values.

In some embodiments which can be used in conjunction with any of the above aspects and embodiments, the chromatographic material is stable over a pH ranging from 2 to 11.

In some embodiments which can be used in conjunction with any of the above aspects and embodiments, the bulk material comprises an inorganic material, a hybrid inorganic-organic material, an organic polymeric material, or a combination thereof.

In some embodiments which can be used in conjunction with any of the above aspects and embodiments, the bulk material comprises an inorganic-organic hybrid material that comprises a network of (a) silicon atoms having four silicon-oxygen bonds and (b) silicon atoms having one or more silicon-oxygen bonds and one or more silicon-carbon bonds. In certain of these embodiments, the bulk material may comprise a substituted or unsubstituted alkylene, alkenylene, alkynylene or arylene moiety bridging two or more silicon atoms, for example, a substituted or unsubstituted C₁-C₈ alkylene, C₁-C₈ alkenylene, C₁-C₈ alkynylene or C₁-C₈ arylene moiety bridging two or more silicon atoms.

In some embodiments which can be used in conjunction with any of the above aspects and embodiments, the bulk material may be formed by hydrolytically condensing (a) one or more silane compounds of the formula SiZ₁Z₂Z₃Z₄, where Z₁, Z₂, Z₃ and Z₄ are independently selected from Cl, Br, I, C₁-C₄ alkoxy, C₁-C₄ alkylamino, and C₁-C₄ alkyl, although at most three of Z₁, Z₂, Z₃ and Z₄ can be C₁-C₄ alkyl, and/or (b) one or more compounds of the formula SiZ₄Z₅Z₆—R SiZ₇Z₈Z₉, where Z₄, Z₅ and Z₆ are independently selected from Cl, Br, I, C₁-C₄ alkoxy, C₁-C₄ alkylamino, and C₁-C₄ alkyl, although at most two of Z₄, Z₅ and Z₆ can be C₁-C₄ alkyl, Z₇, Z₈ and Z₉ are independently selected from Cl, Br, I, C₁-C₄ alkoxy, C₁-C₄ alkylamino, and C₁-C₄ alkyl, although at most two of Z₇, Z₈ and Z₉ can be C₁-C₄ alkyl and where R is C₁-C₄ alkyl.

In some embodiments which can be used in conjunction with any of the above aspects and embodiments, the bulk material may comprise an organic polymer. In certain of these embodiments, the organic polymer may comprise a residue of a hydrophobic organic monomer and a residue of a hydrophilic organic monomer.

In some embodiments which can be used in conjunction with any of the above aspects and embodiments, the zwitterionic polymer further comprises weak cation exchange groups or weak anion exchange groups. In certain of these embodiments, the weak cation exchange groups may comprise carboxyl groups and the weak anion exchange groups may comprise primary, secondary or tertiary amine groups.

Other aspects of the present disclosure pertain to chromatographic separation devices that comprises a chromatographic material in accordance with any of the above aspects and embodiments. Examples of chromatographic separation devices include, for instance, columns.

Other aspects of the present disclosure pertain to chromatographic methods comprising: (a) loading a sample onto a chromatographic separation device comprising a chromatographic material in accordance with any of the above aspects and embodiments and (b) eluting adsorbed species from the chromatographic material with a fluid phase to form an eluent.

In some embodiments, the fluid phase may comprise water, an organic solvent, or a combination of water and organic solvent. In certain of these embodiments, the mobile phase may comprise water and an aprotic organic solvent that is miscible with water.

In some embodiments, which can be used in conjunction with any of the above aspects and embodiments, the chromatographic method is selected from a hydrophilic interaction chromatography (HILIC) method, a size exclusion chromatography (SEC) method, a reverse phase (RP) chromatography method, an ion exchange chromatography method, or a multimode chromatography method, among others.

Still other aspects of the present disclosure pertain to kits that comprise (a) a chromatographic material in accordance with any of the above aspects and embodiments and (b) a chromatographic device.

### BRIEF DESCRIPTION OF THE DRAWINGS

FIG. 1 is a schematic illustration of amide DMAPS polymerization onto an ethylene bridged hybrid (BEH) particle through a surface-bound methacrylate intermediate.

FIG. 2A shows a base peak intensity (BPI) chromatogram for a blank column with no packing.

FIG. 2B shows a base peak intensity (BPI) chromatogram for a column packed with 3.6 μm Amide polyDMAPS functionalized BEH.

FIG. 2C shows a base peak intensity (BPI) chromatogram for a column packed with 3.6 μm Ester polyDMAPS functionalized BEH.

FIG. 2D shows a base peak intensity (BPI) chromatogram for a commercially available 5 μm Zwitterionic column.

FIG. 2E shows spectra taken at specified time intervals for a blank column with no packing.

FIG. 2F shows spectra taken at specified time intervals for a column packed with 3.6 μm Amide polyDMAPS functionalized BEH.

FIG. 2G shows spectra taken at specified time intervals for a column packed with 3.6 μm Ester polyDMAPS functionalized BEH.

FIG. 2H shows spectra taken at specified time intervals for a commercially available 5 μm Zwitterionic column. The axes of FIGS. 2E-2H being linked at 2.19e7.

FIG. 3A shows an extracted ion chromatogram (XIC) at 212 m/z for a column packed with 3.6 μm Amide polyDMAPS functionalized BEH.

FIG. 3B shows an extracted ion chromatogram (XIC) at 212 m/z for a column packed with 3.6 μm Ester polyDMAPS functionalized BEH.

FIG. 3C shows an extracted ion chromatogram (XIC) at 212 m/z for a commercially available column packed with 5 μm zwitterionic-polymer-functionalized polymeric particles. The axes of FIGS. 3A-3C are linked at 2.30e5 (i.e., normalized).

FIG. 3D shows an extracted ion chromatogram (XIC) at 224 m/z for a column packed with 3.6 μm Amide polyDMAPS functionalized BEH.

FIG. 3E shows an extracted ion chromatogram (XIC) at 224 m/z for a a column packed with 3.6 μm Ester polyDMAPS functionalized BEH.

FIG. 3F shows an extracted ion chromatogram (XIC) at 224 m/z for a commercially available column packed with 5 μm zwitterionic-polymer-functionalized polymeric particles. The axes of FIGS. 3D-3F are linked at 2.30e5 (i.e., normalized).

### DETAILED DESCRIPTION

In various aspects, the present disclosure is directed to a chromatographic material that comprises (a) a bulk material and (b) a zwitterionic polymer that comprises one or more zwitterionic monomer residues covalently linked to a surface of the bulk material. The zwitterionic monomer residues are residues of a zwitterionic monomer that contains two charged moieties, a positively charged moiety and a negatively charged moiety, which form a zwitterion. In some embodiments, the zwitterionic species may contain, on average, 1-20 zwitterionic monomer residues, 1-10 zwitterionic monomer residues, 1-6 zwitterionic monomer residues, 1-3 zwitterionic monomer residues, or 1-2 zwitterionic monomer residues.

In various embodiments, the zwitterionic polymer that comprises one or more zwitterionic monomer residues is covalently linked to the surface of the bulk material via a radically polymerizable unsaturated moiety such as an ethylenyl moiety, a vinyl moiety, a methacryloxy moiety, or an acryloxy moiety, among others, that is present at the surface of the bulk material and is able to participate in radical polymerization of one or more zwitterionic monomers (e.g., zwitterionic monomers having radically polymerizable unsaturated functional group), thereby forming the zwitterionic polymer. For example, in some embodiments, the zwitterionic polymer is covalently linked to the surface of the bulk material through a residue of an organosilane monomer (e.g., an alkenyl-functionalized organosilane monomer) that enables radical polymerization of one or more zwitterionic monomers to proceed at the surface of the bulk material, thereby forming the covalently linked zwitterionic polymer. In some embodiments, the molar ratio of the zwitterionic monomer residues to the organosilane monomer residues may range from 0.5 to 20, for example, ranging from 0.5 to 0.75 to 1.0 to 1.5 to 2 to 5 to 10 to 15 to 20. Such polymerization reactions may be conducted under conditions known in the radical polymerization art.

In various embodiments, the positively charged moiety of the zwitterion is a weak anion-exchange moiety such as a primary, secondary or tertiary amine moiety or a strong anion-exchange moiety such as a quaternary amine moiety. In certain of these embodiments, the positively charged moiety may be an acyclic quaternary amine or a cyclic quaternary amine moiety such as a pyridinium moiety or a quinolinium moiety.

In various embodiments, the negatively charged moiety of the zwitterion is a weak cation-exchange moiety such as a carboxylate moiety or a strong cation-exchange moiety such as a sulfonate moiety or a phosphate moiety.

In various embodiments, the positively charged moiety is separated from the negatively charged moiety within the zwitterionic monomer residue by a C₁-C₁₂ alkyl group, more typically, a C₂-C₅ alkyl group and, in some specific embodiments, a C₃ alkyl group.

In various embodiments, the zwitterion of the zwitterionic monomer residue is (a) directly connected to the carbon backbone of the zwitterionic polymer (e.g., a nitrogen atom of a tertiary or quaternary amine directly linked to the carbon backbone), (b) linked to the carbon backbone of the zwitterionic polymer through a C₁-C₁₂ alkyl group, more particularly, through a C₂-C₅ alkyl group, (c) linked to the carbon backbone of the zwitterionic polymer through an amide group, for instance, through a C₁-C₁₂ alkyl amide group, more particularly, through a C₂-C₅ alkyl amide group, where the alkyl group may be attached to the carbon backbone (and the amide group may be located in the middle or at the end of the alkyl group) or wherein the amide group may be attached to the carbon backbone and/or (d) linked to the carbon backbone of the zwitterionic polymer through a urea group, for instance, through a C₁-C₁₂ alkyl urea group, more particularly, through a C₂-C₅ alkyl urea group. In some embodiments, the zwitterion of the zwitterionic monomer residue may be oriented such that the positively charged moiety of the zwitterion is closest to the carbon backbone of the zwitterionic polymer. In some embodiments, the zwitterion of the zwitterionic monomer residue may be oriented such that the negatively charged moiety of the zwitterion is closest to the carbon backbone of the zwitterionic polymer.

In various embodiments, the surface concentration of the zwitterionic monomer residues ranges from 0.5 μmol/m² to 40 μmol/m², for example, ranging from 0.5 μmol/m² to 1 μmol/m² to 2 μmol/m² to 5 μmol/m² to 10 μmol/m² to 20 μmol/m² to 40 μmol/m² (i.e., ranging between any two of these values).

Examples of radically polymerizable zwitterionic monomers that that may be used to form the zwitterionic polymers of the present disclosure may be selected from suitable monomers found in Table 1.

TABLE 1

| ID # | Zwitterionic Monomer Name | CAS | Linkage |
|---|---|---|---|
| Z2 | Dimethyl(methacryloyloxyethyl) ammonium propane | 3637-26-1 | ester |
| | sulfonate | | (comparative) |
| Z1 | Dimethyl(methacryloylaminopropyl) ammonium | 5205-95-8 | amide |
| | propane sulfonate | | |
| Z3 | 3-[(3- | 79704-35-1 | amide |
| | Acrylamidopropyl)dimethylammonio]propanoate | | |
| Z4 | 4-[(3- | 83623-32-9 | amide |
| | Methacrylamidopropyl)dimethylammonio]butane-1- | | |
| | sulfonate | | |
| Z5 | 3-[(3-Acrylamidopropyl)dimethylammonio]propane- | 80293-60-3 | amide |
| | 1-sulfonate | | |
| Z6 | 1-(3-Sulfopropyl)-2-Vinylpyridinium Betaine | 6613-64-5 | alkyl |
| Z7 | Pyridinium, 2-ethenyl-1-(2-hydroxy-3-sulfopropyl)-, | 2227174-63-0 | alkyl |
| | inner salt | | |
| Z8 | Pyridinium, 2-(2-phenylethenyl)-1-(3-sulfopropyl)-, | 62408-61-1 | alkyl |
| | inner salt | | |
| Z9 | Quinolinium, 2-(2-phenylethenyl)-1-(3-sulfopropyl)-, | 1107014-34-5 | alkyl |
| | inner salt | | |
| Z10 | Pyridinium, 2-[(1E)-2-[4-(dimethylamino)phenyl]ethenyl]- | 742068-58-2 | alkyl |
| | 1-(3-sulfopropyl)-, inner salt | | |
| Z11 | Pyridinium, 2-[2-[4-(dimethylamino)phenyl]ethenyl]- | 220681-79-8 | alkyl |
| | 1-(3-sulfopropyl)-, inner salt | | |
| Z12 | Pyridinium, 2-[(1E)-2-[4-(diethylamino)phenyl]ethenyl]- | 861691-59-0 | alkyl |
| | 1-(3-sulfopropyl)-, inner salt | | |
| Z13 | 1-Propanaminium, 2-hydroxy-N,N-dimethyl-N-[3-[(2- | 92206-99-0 | amide |
| | methyl-1-oxo-2-propen-1-yl)amino]propyl]-3-sulfo-, | | |
| | inner salt | | |
| Z14 | 1-Propanaminium, N,N-diethyl-2-hydroxy-N-[3-[(2- | 92207-00-6 | amide |
| | methyl-1-oxo-2-propen-1-yl)amino]propyl]-3-sulfo-, | | |
| | inner salt | | |
| Z15 | 1-Propanaminium, 3-azido-N-methyl-N-[3-[(2- | 2020388-97-8 | amide |
| | methyl-1-oxo-2-propen-1-yl)amino]propyl]-N-(3- | | |
| | sulfopropyl)-, inner salt | | |
| Z16 | 5-Hexen-1-aminium, N,N-dimethyl-N-[3- | 2239348-79-7 | alkyl |
| | (methylamino)propyl]-3-sulfo-, inner salt | | |
| Z17 | 1-Propanaminium, N,N-dimethyl-N-[3-[(1-oxo-3- | 2379974-51-1 | amide |
| | buten-1-yl)amino]propyl]-3-sulfo-, inner salt | | |
| Z18 | 1-Propanaminium, 2-hydroxy-N,N-dimethyl-N-[3-[(1- | 2398472-25-6 | amide |
| | oxo-2-propen-1-yl)amino]propyl]-3-sulfo-, inner salt | | |
| Z19 | 1-Propanaminium, N,N-dimethyl-N-[3-[[(9Z)-1-oxo- | 1192549-38-4 | amide |
| | 9-hexadecen-1-yl]amino]propyl]-3-sulfo-, inner salt | | |
| Z20 | 1-Propanaminium, N,N-dimethyl-N-[3-[[(9Z)-1-oxo- | 1192549-39-5 | amide |
| | 9-octadecen-1-yl]amino]propyl]-3-sulfo-, inner salt | | |
| Z21 | 1-Propanaminium, N,N-dimethyl-N-[3-[[[(2-methyl-1- | 239134-89-5 | urea |
| | oxo-2-propen-1-yl)amino]carbonyl]amino]propyl]-3- | | |
| | sulfo-, inner salt | | |
| Z22 | 1-Propanaminium, N,N-dimethyl-N-[3-[[(13Z)-1-oxo- | 1192549-40-8 | amide |
| | 13-docosen-1-yl]amino]propyl]-3-sulfo-, inner salt | | |
| Z23 | 1-Propanaminium, N,N-dimethyl-N-[3-[[(9Z)-1-oxo- | 2270171-14-5 | amide |
| | 9-docosen-1-yl]amino]propyl]-3-sulfo-, inner salt | | |
| Z24 | 1-Propanaminium, N,N-dimethyl-N-[3-[(1-oxo-13- | 757177-67-6 | amide |
| | docosen-1-yl)amino]propyl]-3-sulfo- | | |
| Z25 | 1-Propanaminium, 2-hydroxy-N,N-dimethyl-N-[3-[(1- | 1374264-05-7 | amide |
| | oxo-9-decen-1-yl)amino]propyl]-3-sulfo-, inner salt | | |
| Z26 | 1-Propanaminium, N-[3-[[(2Z)-3-carboxy-1-oxo-2- | 1898271-83-4 | amide |
| | propen-1-yl]amino]propyl]-2-hydroxy-N,N-dimethyl- | | |
| | 3-sulfo- | | |
| Z27 | 1-Propanaminium, N-[3-[(3-carboxy-1-oxo-2-propen- | 1898271-85-6 | amide |
| | 1-yl)amino]propyl]-2-hydroxy-N,N-dimethyl-3-sulfo- | | |
| Z28 | 1-Propanaminium, 2-hydroxy-N,N-dimethyl-N-[3- | 1374264-29-5 | amide |
| | [[(9E)-1-oxo-9-dodecen-1-yl]amino]propyl]-3-sulfo-, | | |
| | inner salt | | |
| Z29 | 1-Propanaminium, 2-hydroxy-N,N-dimethyl-N-[3-[(1- | 1374570-99-6 | amide |
| | oxo-9-dodecen-1-yl)amino]propyl]-3-sulfo-, inner salt | | |
| Z30 | 1-Propanaminium, 2-hydroxy-N,N-dimethyl-N-[3- | 1192549-36-2 | amide |
| | [[(9Z)-1-oxo-9-hexadecen-1-yl]amino]propyl]-3- | | |
| | sulfo-, inner salt | | |
| Z31 | 1-Propanaminium, 2-hydroxy-N,N-dimethyl-N-[3-[(1- | 1948218-32-3 | amide |
| | oxo-9-octadecen-1-yl)amino]propyl]-3-sulfo-, inner | | |
| | salt | | |
| Z32 | 1-Propanaminium, 2-hydroxy-N,N-dimethyl-N-[3-[(1- | 250140-88-6 | amide |
| | oxo-13-docosen-1-yl)amino]propyl]-3-sulfo-, inner | | |
| | salt | | |
| Z33 | 1-Propanaminium, 2-hydroxy-N,N-dimethyl-N-[3- | 2426578-28-9 | amide |
| | [[(9E,12E,15E)-1-oxo-9,12,15-heptadecatrien-1- | | |
| | yl]amino]propyl]-3-sulfo- | | |
| Z34 | 1-Propanaminium, 3,3′-[(1-oxo-2-propen-1- | 1359860-44-8 | amide |
| | yl)imino]bis[N,N-dimethyl-N-(3-sulfopropyl)-, | | |
| | bis(inner salt) | | |
| Z35 | 2-Butanaminium, N,N′-[[(1-oxo-2-propen-1- | 1916509-55-1 | amide |
| | yl)imino]di-3,1-propanediyl]bis[N,N-dimethyl-4-sulfo-, | | |
| | bis(inner salt) | | |
| Z36 | 1-Propanaminium, 3-[[[(6- | 2475658-90-1 | urea |
| | isocyanatohexyl)amino]carbonyl]amino]- | | |
| | N,N-dimethyl-N-(3-sulfopropyl)-, inner salt | | |
| Z37 | 1-Propanaminium, 3-[[[[4-[(4- | 2475658-89-8 | urea |
| | isocyanatocyclohexyl)methyl]cyclohexyl]amino]carbonyl]amino]- | | |
| | N,N-dimethyl-N-(3-sulfopropyl)-, inner salt | | |
| Z38 | 1-Propanaminium, 3-[[[[(5-isocyanato-1,3,3- | 2475658-88-7 | urea |
| | trimethylcyclohexyl)methyl]amino]carbonyl]amino]- | | |
| | N,N-dimethyl-N-(3-sulfopropyl)-, inner salt | | |

Additional zwitterionic monomers that are able to participate in radical polymerization may be generated from known zwitterionic compounds by functionalizing such compounds with an radically polymerizable unsaturated functional group to allow for participation in polymerization reactions. Such zwitterionic compounds include those shown in Table 2, among others.

TABLE 2

| ID # | Zwitterionic Compound Name | CAS | Linkage |
|---|---|---|---|
| Z39 | 1-Propanaminium, 3-[(4-heptylbenzoyl)amino]-N,N- | 565454-38-8 | amide |
| | dimethyl-N-(3-sulfopropyl)-, inner salt | | |
| Z40 | 1-Propanaminium, 3-[(4-decylbenzoyl)amino]-N,N- | 216667-43-5 | amide |
| | dimethyl-N-(3-sulfopropyl)-, inner salt | | |
| Z41 | 1-Propanaminium, N,N-dimethyl-N-[3-[[4- | 565454-42-4 | amide |
| | (octyloxy)benzoyl]amino]propyl]-3-sulfo-, inner salt | | |
| Z42 | 1-Propanaminium, N-ethyl-2-hydroxy-N-methyl-N-[3- | 1262437-92-2 | amide |
| | [(4-octylbenzoyl)amino]propyl]-3-sulfo-, inner salt | | |
| Z43 | 1-Propanaminium, 3-[(hydroxymethyl)(3- | 82130-38-9 | amide |
| | pyridinylcarbonyl)amino]-N,N-dimethyl-N-(3- | | |
| | sulfopropyl)-, inner salt | | |
| Z44 | 1-Propanaminium, 3-amino-N-[3-[[(3′,6′-dihydroxy-3- | 1349808-51-0 | amide |
| | oxospiro[isobenzofuran-1(3H),9′-[9H]xanthen]-5- | | |
| | yl)carbonyl]amino]propyl]-N-methyl-N-(3-sulfopropyl)-, | | |
| | inner salt | | |
| Z45 | 1-Propanaminium, 3-[(4-carboxy-1-oxobutyl)amino]- | 1349809-05-7 | amide |
| | N-[3-[[(3′,6′-dihydroxy-3-oxospiro[isobenzofuran- | | |
| | 1(3H),9′-[9H]xanthen]-5-yl)carbonyl]amino]propyl]- | | |
| | N-methyl-N-(3-sulfopropyl)-, inner salt | | |
| Z46 | 1,3-Propanediaminium, N1,N1,N3,N3-tetramethyl-N1,N3- | 1242745-61-4 | alkyl |
| | bis(3-sulfopropyl)-, bis(inner salt) | | |
| Z47 | 1-Propanaminium, 3-(dimethylamino)-N,N-dimethyl- | 1379044-68-4 | alkyl |
| | N-(3-sulfopropyl)-, inner salt | | |
| Z48 | 1-Propanaminium, N-(2-hydroxyethyl)-3-[(2- | 1379044-66-2 | alkyl |
| | hydroxyethyl)methylamino]-N-methyl-N-(3- | | |
| | sulfopropyl)-, inner salt | | |
| Z49 | 1-Propanaminium, 2-hydroxy-N-[3-[(2- | 66137-96-0 | alkyl |
| | hydroxyethyl)methylamino]propyl]-N,N-dimethyl-3-sulfo-, | | |
| | inner salt | | |
| Z50 | 1-Propanaminium, N-[3-(formylamino)propyl]-2- | 120128-91-8 | amide |
| | hydroxy-N,N-dimethyl-3-sulfo-, inner salt | | |
| Z51 | 1-Propanaminium, 3-[(3-mercapto-1-oxopropyl)amino]- | 2245191-34-6 | amide |
| | N,N-dimethyl-N-(3-sulfopropyl)-, inner salt | | |
| Z52 | 1,3-Propanediaminium, N1,N3-bis(2-hydroxy-3- | 97919-34-1 | alkyl |
| | sulfopropyl)-N1,N1,N3,N3-tetramethyl-, bis(inner salt) | | |
| Z53 | 1-Propanaminium, 3-amino-N,N-dimethyl-N-(3- | 54580-96-0 | alkyl |
| | sulfopropyl)-, inner salt | | |
| Z54 | 1-Propanaminium, 3-amino-N-(3-aminopropyl)-N- | 1307950-88-4 | alkyl |
| | methyl-N-(3-sulfopropyl)-, inner salt | | |
| Z55 | 1-Propanaminium, 3-isocyano-N,N-dimethyl-N-(3- | 260049-81-8 | alkyl |
| | sulfopropyl)-, inner salt | | |
| Z56 | 1-Propanaminium, N-(3-aminopropyl)-2-hydroxy-N,N- | 86880-59-3 | alkyl |
| | dimethyl-3-sulfo-, inner salt | | |
| Z57 | 1-Propanaminium, 3-(chloroamino)-2-hydroxy-N,N- | 123647-83-6 | alkyl |
| | dimethyl-N-(3-sulfopropyl)-, inner salt | | |
| Z58 | 1-Propanaminium, 3-[(3-carboxy-1-oxopropyl)amino]- | 936249-36-4 | amide |
| | N,N-dimethyl-N-(3-sulfopropyl)-, inner salt | | |
| Z59 | 1-Propanaminium, N,N-dimethyl-N-[3-[(1-oxo-12- | 2378647-08-4 | amide |
| | thioxotridecyl)amino]propyl]-3-sulfo-, inner salt | | |
| Z60 | 1-Propanaminium, 3-[(4-carboxy-1-oxobutyl)amino]- | 1675837-71-4 | amide |
| | N,N-dimethyl-N-(3-sulfopropyl)-, inner salt | | |
| Z61 | 1-Propanaminium, 3-[[5-(1,2-dithiolan-3-yl)-1- | 1422670-59-4 | amide |
| | oxopentyl]amino]-N,N-dimethyl-N-(3-sulfopropyl)-, | | |
| | inner salt | | |

The bulk material of the chromatographic material may be selected, for example, from (a) inorganic materials (e.g., silica, alumina, titania, zirconia, etc.), (b) organic polymeric materials, (c) hybrid inorganic-organic materials, (d) materials having an inorganic core with one or more hybrid inorganic-organic shell layers or with one or more organic polymer shell layers, (e) materials having a hybrid inorganic-organic core with one or more inorganic shell layers or with one or more organic polymer shell layers, (f) materials having an organic polymer core with one or more inorganic shell layers or with one or more hybrid inorganic-organic shell layers, or (g) materials having a hybrid inorganic-organic core with one or more different hybrid inorganic-organic shell layers, among other possibilities.

In various embodiments, the bulk material of the chromatographic material may comprise a silicon-based material. For example, the bulk material of the chromatographic material may be silica in some embodiments.

As another example, in some embodiments, the bulk material of the chromatographic material may comprise a silicon-based inorganic-organic hybrid material that includes inorganic regions in which the material comprises silicon atoms having four silicon-oxygen bonds and hybrid regions in which the material comprises silicon atoms having one or more silicon-oxygen bonds and one or more silicon-carbon bonds. In some cases the hybrid regions may comprise a substituted or unsubstituted alkylene, alkenylene, alkynylene or arylene moiety bridging two or more silicon atoms. For example the hybrid regions may comprise a substituted or unsubstituted C₁-C₁₈ alkylene, C₂-C₁₈ alkenylene, C₂-C₁₈ alkynylene or C₆-C₁₈ arylene moiety bridging two or more silicon atoms. In particular embodiments, the hybrid regions may comprise a substituted or unsubstituted C₁-C₆ alkylene moiety bridging two or more silicon atoms, including methylene, dimethylene or trimethylene moieties bridging two silicon atoms. In particular embodiments, the hybrid regions comprises may comprise ≡Si—(CH₂)ₙ—Si≡ moieties, where n is an integer, and may be equal to 1, 2, 3, 4 or more.

In various embodiments, the silicon-based inorganic-organic hybrid bulk material may be formed by hydrolytically condensing one or more silane compounds, which typically include (a) one or more silane compounds of the formula SiZ₁Z₂Z₃Z₄, where Z₁, Z₂, Z₃ and Z₄ are independently selected from Cl, Br, I, C₁-C₄ alkoxy, C₁-C₄ alkylamino, and C₁-C₄ alkyl, although at most three of Z₁, Z₂, Z₃ and Z₄ can be C₁-C₄ alkyl, for example, tetraalkoxysilanes, including tetra-C₁-C₄-alkoxysilanes such as tetramethoxysilane or tetraethoxysilane, alkyl-trialkoxysilanes, for example, C₁-C₄-alkyl-tri-C₁-C₄-alkoxysilanes, such as methyl triethoxysilane, methyl trimethoxysilane, or ethyl triethoxysilane, and dialkyl-dialkoxysilanes, for example, C₁-C₄-dialkyl-di-C₁-C₄-alkoxysilanes, such as dimethyl diethoxysilane, dimethyl dimethoxysilane, or diethyl diethoxysilane, among many other possibilities and/or (b) one or more compounds of the formula Si Z₁Z₂Z₃—R—SiZ₄Z₅Z₆, where Z₁, Z₂ and Z₃ are independently selected from Cl, Br, I, C₁-C₄ alkoxy, C₁-C₄ alkylamino, and C₁-C₄ alkyl, although at most two of Z₁, Z₂ and Z₃ can be C₁-C₄ alkyl, where Z₄, Z₅ and Z₆ are independently selected from Cl, Br, I, C₁-C₄ alkoxy, C₁-C₄ alkylamino, and C₁-C₄ alkyl, although at most two of Z₄, Z₅ and Z₆ can be C₁-C₄ alkyl, where R is an organic radical, for example, selected from C₁-C₁₈ alkylene, C₂-C₁₈ alkenylene, C₂-C₁₈ alkynylene or C₆-C₁₈ arylene groups, for example, C₁-C₄ alkylene in various embodiments. Examples include bis(trialkoxysilyl)alkanes, for instance, bis(tri-C₁-C₄-alkoxysilyl)C₁-C₄-alkanes such as bis(trimethoxysilyl)methane, bis(trimethoxysilyl)ethane, bis(triethoxysilyl)methane, and bis(triethoxysilyl)ethane, among many other possibilities.

In some embodiments, silicon-based inorganic-organic hybrid bulk material may be formed by hydrolytically condensing one or more alkoxysilane compounds. Examples of alkoxysilane compounds include, for instance, tetraalkoxysilanes (e.g., tetramethoxysilane (TMOS), tetraethoxysilane (TEOS), etc.), alkylalkoxysilanes such as alkyltrialkoxysilanes (e.g., methyl trimethoxysilane, methyl triethoxysilane (MTOS), ethyl triethoxysilane, etc.) and bis(trialkoxysilyl)alkanes (e.g., bis(trimethoxysilyl)methane, bis(trimethoxysilyl)ethane, bis(triethoxysilyl)methane, bis(triethoxysilyl)ethane (BTE), etc.), as well as combinations of the foregoing. In certain of these embodiments, silicon-based inorganic-organic hybrid materials may be prepared from two alkoxysilane compounds, for example, a tetraalkoxysilane such as TMOS or TEOS and an alkylalkoxysilane such as MTOS or a bis(trialkoxysilyl)alkane such as BTEE. When BTEE is employed, the resulting materials are organic-inorganic hybrid materials, which are sometimes referred to as ethylene bridged hybrid (BEH) materials and can offer various advantages over conventional silica, including chemical and mechanical stability. One particular BEH material can be formed from hydrolytic condensation of TEOS and BTEE.

Further inorganic-organic hybrid materials and methods for forming inorganic-organic hybrid particles described in U.S. Pat. No. 6,686,035B2, which is hereby incorporated herein by reference.

The bulk material can be fully or superficially porous and contain a surrounding material that is organic, inorganic or a combination thereof as described in U.S. Pat. No. 10,092,893; in U.S. Patent Publication No. US20130112605; and in U.S. Patent Publication No. US20190015815, which are hereby incorporated herein by reference.

In various embodiments, the bulk material may comprise a hydrolytically condensed alkenyl-functionalized organosilane monomer, thereby providing the bulk material with alkenyl-functionalized groups from which organic polymerization can proceed from the bulk material, specifically, polymerization of one or more zwitterionic monomers such as those previously described to form covalently attached zwitterionic polymers such as those previously described.

Specific examples of alkenyl-functionalized organosilane monomers include 3-(trimethoxysilyl)propyl methacrylate (also so known as 3-methacryloxypropyltrimethoxysilane, or MAPTMOS, methacryloxypropyltriethoxysilane, methacryloxypropyltrichlorosilane, vinyltriethoxysilane (VTES), vinyltrimethoxy silane, N-(3-acryloxy-2-hydroxypropyl)-3-aminopropyltriethoxysilane, (3-acryloxypropyl)trimethoxysilane, O-(methacryloxyethyl)-N-(triethoxysilylpropyl)urethane, N-(3-methacryl oxy-2-hydroxypropyl)-3-aminopropyltriethoxysilane, methacryloxymethyltriethoxysilane, methacryloxymethyltrimethoxysilane, methacryloxypropylmethyldiethoxysilane, methacryloxypropylmethyldimethoxysilane, methacryloxypropyltris(methoxyethoxy)silane, 3-(N-styrylmethyl-2-aminoethylamino)propyltrimethoxysilane hydrochloride, among others.

In some embodiments, a concentration of silanol groups at a surface of a given silicon-based material may be reduced by reaction with one or more suitable organosilane compounds, for example, one or more silane compounds of the formula SiZ₇Z₈Z₉Z₁₀, where Z₇, Z₈, Z₉ and Z₁₀ are independently selected from Cl, Br, I, C₁-C₁₈ alkyl, C₂-C₁₈ alkenyl, C₂-C₁₈ alkynyl or C₆-C₁₈ aryl, wherein at least one and at most three of Z₇, Z₈, Z₉ and Z₁₀ is C₁-C₁₈ alkyl, C₂-C₁₈ alkenyl, C₂-C₁₈ alkynyl or C₆-C₁₈ aryl. In some embodiments, at least one and at most three of Z₇, Z₈, Z₉ and Z₁₀ is C₁-C₄ alkyl. In certain embodiments, silanol groups at a surface of the silicon-based bulk materials may be reduced in concentration by reaction with a haloalkylsilane compound selected from a chlorotrialkylsilane, a dichlorodialkylsilane or a trichloroalkylsilane, such as chlorotrimethylsilane, trimethylchlorosilane or dimethyldiclorosilane.

As previously indicated, in various embodiments, the bulk material of the chromatographic material may comprise an organic polymer material. In some of these embodiments, the bulk material may comprise an organic copolymer that comprises residues of at least one hydrophobic organic monomer and residues of at least one hydrophilic organic monomer. Organic polymer materials commonly contain residual radical-polymerizable unsaturated surface moieties (e.g., ethylenyl moieties, vinyl moieties, methacryloxy moieties, or acryloxy moieties, etc.), from which polymerization of one or more zwitterionic monomers can proceed.

In certain embodiments, the hydrophilic organic monomer may be selected from organic monomers having an amide group, organic monomers having an ester group, organic monomers having a carbonate group, organic monomers having a carbamate group, organic monomers having a urea group, organic monomers having a hydroxyl group, and organic monomers having nitrogen-containing heterocyclic group, among other possibilities. Specific examples of hydrophilic organic monomers include, for example, 2-vinylpyridine, 3-vinylpyridine, 4-vinylpyridine, N-vinylpyrrolidone, N-vinyl-piperidone, N-vinyl caprolactam, lower alkyl acrylates (e.g., methyl acrylate, ethyl acrylate, etc.), lower alkyl methacrylates (e.g., methyl methacrylate, ethyl methacrylate, etc.), vinyl acetate, acrylamide or methacrylamide, hydroxypolyethoxy allyl ether, ethoxy ethyl methacrylate, ethylene glycol dimethacrylate, or diallyl maleate. In particular embodiments, the hydrophilic organic monomer may be a monomer having the following formula,

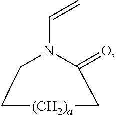

where n ranges from 1-3 (i.e., N-vinyl pyrrolidone, N-vinyl-2-piperidinone or N-vinyl caprolactam).

In certain embodiments, the hydrophobic organic monomer of the organic copolymer may comprise a C₂-C₁₈ olefin monomer and/or a monomer comprising a C₆-C₁₈ monocyclic or multicyclic carbocyclic group (e.g., a phenyl group, a phenylene group, naphthalene group, etc.). Specific examples of hydrophobic organic monomers include, for example, monofunctional and multifunctional aromatic monomers such as styrene and divinylbenzene, monofunctional and multifunctional olefin monomers such as ethylene, propylene or butylene, polycarbonate monomers, ethylene terephthalate, monofunctional and multifunctional fluorinated monomers such as fluoroethylene, 1,1-(difluoroethylene), tetrafluoroethylene, chlorotrifluoroethylene, hexafluoropropylene, perfluoropropylvinylether, or perfluoromethylvinylether, monofunctional or multifunctional acrylate monomers having a higher alkyl or carbocyclic group, for example, monofunctional or multifunctional acrylate monomers having a C₆-C₁₈ alkyl, alkenyl or alkynyl group or a C₆-C₁₈ saturated, unsaturated or aromatic carbocyclic group, monofunctional or multifunctional methacrylate monomers having a higher alkyl or carbocyclic group, for example, monofunctional or multifunctional methacrylate monomers having a C₆-C₁₈ alkyl, alkenyl or alkynyl group or a C₆-C₁₈ saturated, unsaturated or aromatic carbocyclic group, among others. In certain embodiments, DVB 80 may be employed, which is an organic monomer mixture that comprises divinylbenzene (80%) as well as a mixture of ethyl-styrene isomers, diethylbenzene, and can include other isomers as well.

In certain embodiments, the organic copolymer may comprise residues of multifunctional hydrophobic organic monomer such as divinylbenzene and/or a multifunctional hydrophilic organic monomer, such as ethylene glycol dimethacrylate, methylene bisacrylamide or allyl methacrylate, in order to provide crosslinks in the organic copolymer.

In certain embodiments, the organic copolymer may comprise residues of n-vinyl pyrrolidone or n-vinyl caprolactam as a hydrophilic organic monomer residues and residues of divinylbenzene as a hydrophobic organic monomer residues.

Such copolymers may be formed using various methods of free radical polymerization well known in the art. Particles may be formed, for example, as described in U.S. Patent Pub. Nos. 2012/0248033 and 2012/0248033

In various embodiments, residual unsaturated groups in the organic polymer bulk material provide a basis from which organic polymerization can proceed from the bulk material, specifically, polymerization of one or more zwitterionic monomers such as those previously described to form covalently attached zwitterionic polymers such as those previously described.

In various embodiments, in addition to a bulk material and a zwitterionic polymer covalently linked to a surface of the bulk material, the chromatographic materials of the present disclosure may further comprise (a) hydrophobic surface groups, for example, surface groups comprising hydrocarbon or fluorocarbon groups, typically alkyl groups, aromatic groups, or alkyl-aromatic groups, which may contain from 6 to 30 carbon atoms, and which are optionally substituted with one or more fluorine atoms, (b) weak cation exchange surface groups, for example, surface carboxyl groups, and/or (c) weak anion exchange surface groups, for example, primary, secondary or tertiary amine surface groups.

In various embodiments, the bulk materials described herein may be in monolithic form.

In various embodiments, the bulk materials described herein may be in particulate form. For example, the chromatographic materials may be in the form of particles, typically spherical particles, having a diameter ranging from 0.25 to 100 μm, for example, ranging from 0.25 μm to 0.5 μm to 1 μm to 2.5 μm to 5 μm to 10 μm to 25 μm to 50 μm to 100 μm (i.e., ranging between any two of the preceding values).

In various embodiments, the bulk materials described herein may be a porous material or a superficially porous material (i.e., a material having a non-porous core region and one or more porous shell regions disclosed over the core region).

In various embodiments, the porous or superficially porous material may have a pore size (average pore diameter) ranging from 45 to 3000 Angstroms, for example ranging from 45 to 100 to 250 to 500 to 1000 to 3000 Angstroms, as measured by conventional porosimetry methods. For sub-500 Angstrom pores, the average pore diameter (APD) can be measured using the multipoint N₂ sorption method (Micromeritics ASAP 2400; Micromeritics Instruments Inc., Norcross, Ga.), with APD being calculated from the desorption leg of the isotherm using the BJH method as is known in the art. Hg porosimetry may be used for pores that are 400 Angstrom or greater, as is known in the art.

In various embodiments, the chromatographic materials described herein may stable over pH ranging from 2 to 11.

In some aspects of the present disclosure, the chromatographic materials described herein may be provided in a suitable chromatographic device. For this purpose, the chromatographic materials described herein may be provided in conjunction with a suitable housing. The chromatographic material and the housing may be supplied independently, or the chromatographic material may be pre-packaged in the housing, for example, in the form of a packed bed of chromatographic particles. Housings for use in accordance with the present disclosure commonly include a chamber for accepting and holding chromatographic material. In various embodiments, the housings may be provided with an inlet and an outlet leading to and from the chamber.

Suitable construction materials for the chromatographic housings include inorganic materials, for instance, metals such as stainless steel and ceramics such as glass, as well as synthetic polymeric materials such as polyethylene, polypropylene, polyether ether ketone (PEEK), and polytetrafluoroethylene, among others.

In certain embodiments, the chromatographic housings may include one or more filters which act to hold the chromatographic material in a housing. Exemplary filters may be, for example, in a form of a membrane, screen, frit or spherical porous filter.

In certain embodiments, the chromatographic device is a chromatographic column.

The present disclosure also provides for a kit comprising the chromatographic materials, housings or devices as described herein and instructions for use. In one embodiment, the instructions are for use with a separations device, e.g., a chromatographic column.

In other aspects of the present disclosure, the chromatographic materials of the present disclosure can be used in a variety of chromatographic separation methods. As such, the chromatographic devices and chromatographic kits described herein can also be utilized for such methods. Examples of chromatographic separation methods that the chromatographic materials of the invention can be used in include, but are not limited to, hydrophilic interaction chromatography (HILIC) separations, high pressure liquid chromatography (HPLC) separations, ultra-high liquid chromatography (UHLC) separations, normal-phase separations, reversed-phase separations, chiral separations, supercritical fluid chromatography SFC separations, affinity separations, perfusive separations, and size-exclusion chromatography (SEC) separations, or multimode separations, among others.

The chromatographic materials, devices and kits of the present disclosure may be used for chromatographic separations of small molecules, carbohydrates, antibodies, whole proteins, peptides, and/or DNA, among other species.

Such chromatographic separations may comprise loading a sample onto a chromatographic material in accordance with the present disclosure and eluting adsorbed species from the chromatographic material with a mobile phase.

Such chromatographic separations may be performed in conjunction with a variety of aqueous and/or organic mobile phases (i.e., in mobile phases that contain water, an organic solvent, or a combination of water and organic solvent) and in conjunction with a variety of mobile phase gradients, including solvent species gradients, temperature gradients, pH gradients, salt concentration gradients, or gradients of other parameters.

In the specific case of HILIC separations, a typical mobile phase includes acetonitrile (ACN) with a small amount of water. However, any aprotic solvent miscible with water may be used as a polar aprotic solvent, including acetonitrile, acetone, tetrahydrofuran, methylene chloride, ethyl acetate, N,N-dimethylformamide, dimethyl sulfoxide, dioxane and dimethyl ether, among others.

### Example 1

BEH porous hybrid particles were prepared following the method as described in U.S. Pat. No. 6,686,035 (incorporated herein by reference in its entirety) and surface modified by techniques known to those skilled in the art. More particularly, anhydrous BEH porous hybrid particles were surface modified with an alkenyl-functionalized organosilane (methacryloxypropyltrichlorosilane) through a reaction in toluene at elevated temperature for 4 h in the presence of a catalyst (diisopropylethylamine). The reaction mixture was cooled, and the particles were isolated, washed, transferred to a clean reaction vessel, heated for 3 h in an aqueous acetone solution (pH 7), cooled, isolated, washed, and dried under vacuum.

TABLE 3

| | Surface Coverage by % C |
|---|---|
| Product | (μmol/m²) |
| 1a | 1.76 |
| 1b | 1.76 |
| 1c | 1.82 |
| 1d | 1.58 |
| 1e | 2.75 |
| 1f | 2.05 |
| 1g | 1.72 |

### Example 2

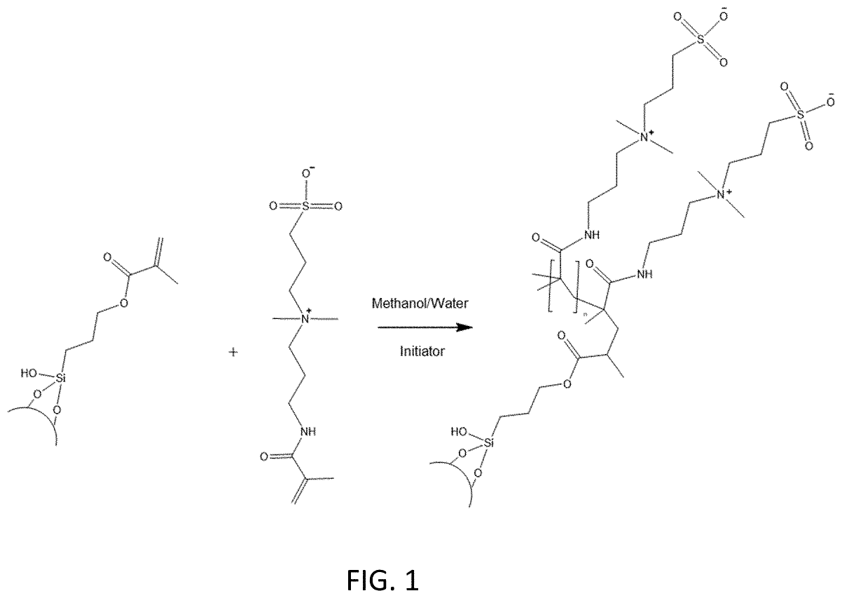

Polymerization of a zwitterionic polymer was then conducted from the alkenyl-functionalized surface of the modified BEH particles of Example 1 along the lines schematically shown in FIG. 1 using techniques known to those skilled in the art. More particularly, either zwitterionic sulfobetaine monomer (Z1, dimethyl(methacryloylaminopropyl) ammonium propane sulfonate (Amide DMAPS), or Z2, dimethyl(methacryloyloxyethyl) ammonium propane sulfonate (Ester DMAPS monomer), from Table 4) was covalently bonded to the alkenyl-functionalized surface of the surface modified BEH particles of Example 1 by polymerization in the presence of a polymerization initiator in aqueous methanol solution at elevated temperature for 3-20 h. The reaction mixture was then cooled, and the particles were isolated, washed, transferred into a clean reaction vessel, heated in an aqueous solution (pH 2-10), cooled, isolated, washed to neutral pH, and dried under vacuum. The resulting particles were submitted for elemental analysis, specifically, CHN (carbon, hydrogen and nitrogen analysis) and TGA (thermogravimetric analysis). Several prototypes formed from Amide DMAPS and Ester DMAPS are shown in Table 5.

TABLE 4

| | | Reference |
|---|---|---|
| Designation | Zwitterionic Monomer Name | Name |
| Z1 | Dimethyl(methacryloylaminopropyl) | Amide |
| | ammonium propane sulfonate | DMAPS |
| Z2 | Dimethyl(methacryloyloxyethyl) | Ester |
| | ammonium propane sulfonate | DMAPS |

TABLE 5

| | | | | Surface |
|---|---|---|---|---|
| | Precursor | Monomer | Monomer | Coverage by % N |
| Product | Name | Type | Charge (M) | (μmol/m²) |
| 2a | 1a | Z1 | 0.19 | 2.34 |
| 2b | 1b | Z2 | 0.19 | 2.37 |
| 2c | 1b | Z1 | 0.18 | 2.41 |
| 2d | 1a | Z1 | 0.11 | 2.02 |
| 2e | 1a | Z1 | 0.15 | 2.30 |
| 2f | 1c | Z2 | 0.09 | 1.86 |
| 2g | 1g | Z1 | 0.34 | 4.22 |

### Example 3

The method as described in Example 2 is expanded to include other zwitterionic monomers of interest, such as, but not limited to those additional monomers listed in Table 1 in combination with precursor particles capable of participating in polymerization, for example, particles such as the BEH particles described in Example 1 μmodified with a methacrylate silane monomer.

### Example 4

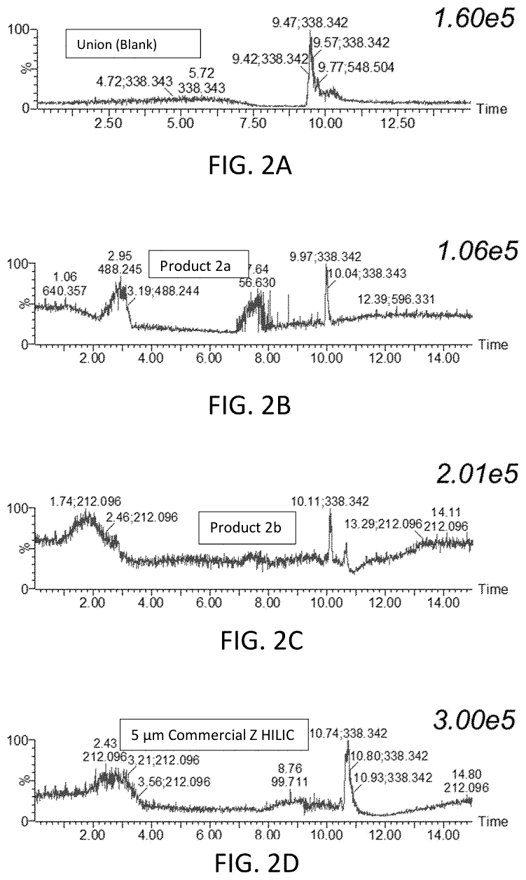

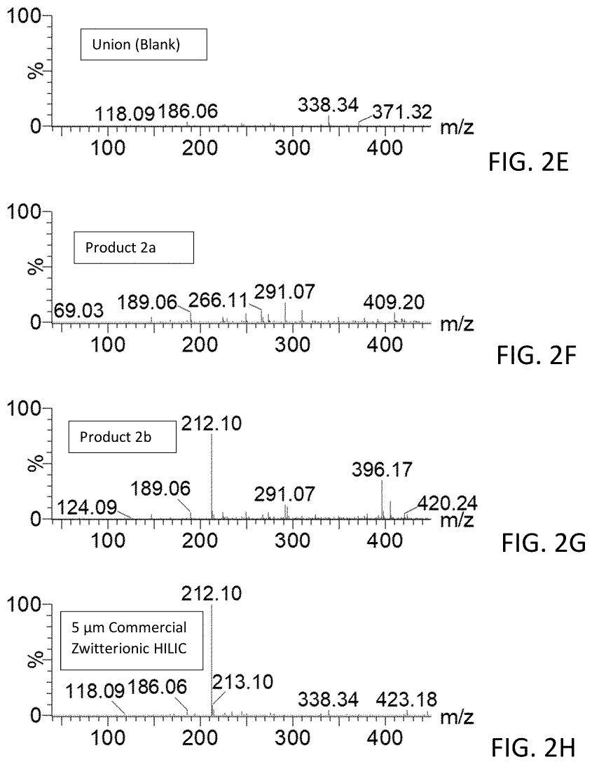

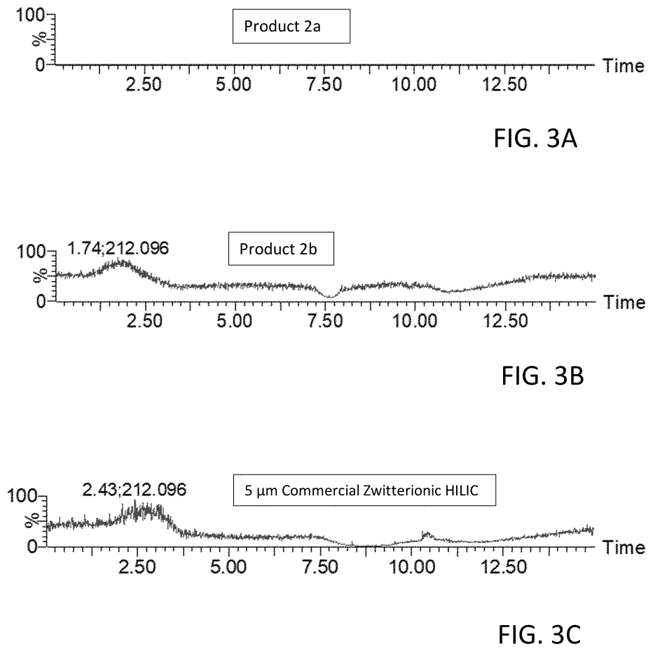

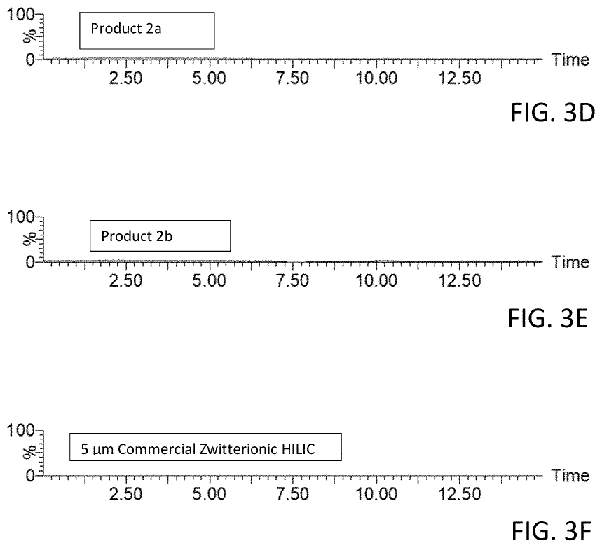

Prototypes prepared from the methods described in Examples 1 and 2, specifically, the products of Product 2a and Product 2b in Table 5, were packed into 2.1×100 mm columns and evaluated for stationary phase bleed during LC/MS (see FIGS. 2A-2B, FIGS. 3A-3B, and Table 6, which shows the LC gradient used for the evaluations, where mobile phase A is acetonitrile and mobile phase B is 20 mM ammonium carbonate, pH 9.0) using the instrument and conditions described as follows: System: Waters ACQUITY I-Class with CM and XEVO G2-XS Q TOF; Columns: 2.1×100 mm; Column Temp: 30° C.; Mobile Phase A: acetonitrile; Mobile Phase B: 20 mM ammonium carbonate, pH 9.0; Flow Rate: 0.4 μmL/min (for commercially available Zwitterionic HILIC column, flow rate: 0.2 μmL/min); Gradient: See Table 6, Sample: None; Detection: XEVO Q TOF in ESI positive (1 kV) mode.

TABLE 6

| Time (min) | Flow (mL/min) | % A | % B |
|---|---|---|---|
| Initial | 0.4 | 80 | 20 |
| 8.00 | 0.4 | 20 | 80 |
| 9.00 | 0.4 | 20 | 80 |
| 10.00 | 0.4 | 80 | 20 |
| 15.00 | 0.4 | 80 | 20 |

Base peak intensity (BPI) chromatograms (FIG. 2A, FIG. 2B, FIG. 2C, and FIG. 2D) and relevant spectra taken at specified time intervals (FIG. 2E, FIG. 2F, FIG. 2G and FIG. 2H) are shown for the following: a blank column with no packing (FIG. 2A and FIG. 2E), a column packed with 3.6 μm Amide polyDMAPS functionalized BEH (Table 5, Product 2a, FIG. 2B and FIG. 2F), a column packed with 3.6 μm Ester polyDMAPS functionalized BEH (Table 5, Product 2b, FIG. 2C and FIG. 2G), and a 5 μm commercially available Zwitterionic column (FIG. 2D and FIG. 2H. The extracted spectra from the base peak intensity (BPI) chromatograms at the specified time intervals (FIG. 2E, FIG. 2F, FIG. 2G and FIG. 2H) show that the most intense ion present in both the Ester polyDMAPS and commercially available Zwitterionic HILIC column (i.e., 212 m/z), does not appear to be present in the Amide polyDMAPS column.

Extracted ion chromatograms (XIC) with normalized axes confirm no signal at 212 m/z for the Amide polyDMAPS column (FIG. 3A for product 2a, FIG. 3B for product 2b, and FIG. 3C for commercially available Zwitterionic HILIC column). Analogous to cleavage at the ester moiety in Ester polyDMAPS materials resulting in an MS signal at 212 m/z, cleavage at the amide moiety in Amide polyDMAPS would theoretically result in an MS signal at 224 m/z; signal intensity at 224 m/z, however, is nearly undetectable for the Amide polyDMAPS under these conditions (FIG. 3D for product 2a, FIG. 3E for product 2b, and FIG. 3F for commercially available Zwitterionic HILIC column).

1. A chromatographic material comprising (a) a bulk material and (b) a zwitterionic polymer covalently linked to a surface of the bulk material, the zwitterionic polymer comprising one or more monomer residues that comprise an amide or urea moiety, a positively charged moiety and a negatively charged moiety.

2. The chromatographic material of claim 1, wherein the amide or urea moiety, the positively charged moiety and the negatively charged moiety are separated from one another by C₁-C₁₂ alkyl groups.

3. The chromatographic material of claim 2, wherein the positively charged moiety is a quaternary ammonium moiety and wherein the negatively charged moiety is a sulfate moiety, a sulfonate moiety, a phosphate moiety or a phosphonate moiety.

4. The chromatographic material of claim 1, wherein the zwitterionic polymer comprises a residue of a monomer that comprises a sulfobetaine moiety containing an amide linkage or a urea linkage.

5. The chromatographic material of claim 1, wherein the zwitterionic polymer comprises a di-C₁-C₅-alkyl(methacryloylamino-C₁-C₁₂-alkyl) ammonium C₁-C₁₂-alkane sulfonate monomer residue.

6. The chromatographic material of claim 1, wherein the zwitterionic polymer comprises a dimethyl(methacryloylaminopropyl) ammonium propane sulfonate monomer residue.

7. The chromatographic material of claim 1, wherein the zwitterionic polymer is covalently linked to the surface of the bulk material through a residue of an organosilane monomer that is able to participate in radical polymerization.

8. The chromatographic material of claim 1, wherein the zwitterionic polymer is covalently linked to the surface of the bulk material through a residue of an alkenyl-functionalized organosilane monomer.

9. The chromatographic material of claim 8, wherein the alkenyl-functionalized organosilane monomer is selected from 3-methacryloxypropyltrimethoxysilane (MAPTMOS), methacryloxypropyltrichlorosilane, 3-methacryloxypropyltriethoxysilane, vinyltriethoxysilane (VTES), vinyltrimethoxy silane, N-(3-acryloxy-2-hydroxypropyl)-3-aminopropyltriethoxysilane, (3-acryloxypropyl)trimethoxysilane, O-(methacryloxyethyl)-N-(triethoxysilylpropyl)urethane, N-(3-methacryl oxy-2-hydroxypropyl)-3-aminopropyltricthoxysilane, methacryloxymethyltriethoxysilane, methacryloxymethyltrimethoxysilane, methacryloxypropylmethyldiethoxysilane, methacryloxypropylmethyldimethoxysilane, methacryloxypropyltris(methoxyethoxy)silane, or 3-(N-styrylmethyl-2-aminoethylamino)propyltrimethoxysilane hydrochloride.

10. The chromatographic material of claim 1, wherein the bulk material is a porous or a superficially porous material.

11. The chromatographic material of claim 10, wherein the chromatographic material has a surface pore size ranging from 45 to 3000 Å.

12. The chromatographic material of claim 1, wherein the bulk material is a monolithic material.

13. The chromatographic material of claim 1, wherein the bulk material is a particulate material.

14. The chromatographic material of claim 13, wherein the particulate material has a particle size ranging from 0.3 to 100 μm.

15. The chromatographic material of claim 1, wherein the chromatographic material is stable over pH ranging from 2 to 11.

16. The chromatographic material of claim 1, wherein the bulk material comprises an inorganic material, a hybrid inorganic-organic material, an organic polymeric material, or a combination thereof.

17. The chromatographic material of claim 1, wherein the bulk material comprises an inorganic-organic hybrid material that comprises a network of (a) silicon atoms having four silicon-oxygen bonds and (b) silicon atoms having one or more silicon-oxygen bonds and one or more silicon-carbon bonds.

18. The chromatographic material of claim 17, wherein the bulk material comprises a substituted or unsubstituted alkylene, alkenylene, alkynylene or arylene moiety bridging two or more silicon atoms.

19. The chromatographic material of claim 1, wherein the bulk material, is formed by hydrolytically condensing (a) one or more silane compounds of the formula SiZ₁Z₂Z₃Z₄, where Z₁, Z₂, Z₃ and Z₄ are independently selected from Cl, Br, I, C₁-C₄ alkoxy, C₁-C₄ alkylamino, and C₁-C₄ alkyl, although at most three of Z₁, Z₂, Z₃ and Z₄ can be C₁-C₄ alkyl, and/or (b) one or more compounds of the formula SiZ₄Z₅Z₆—R—SiZ₇Z₈Z₉, where Z₄, Z₅ and Z₆ are independently selected from Cl, Br, I, C₁-C₄ alkoxy, C₁-C₄ alkylamino, and C₁-C₄ alkyl, although at most two of Z₄, Z₅ and Z₆ can be C₁-C₄ alkyl, Z₇, Z₈ and Z₉ are independently selected from Cl, Br, I, C₁-C₄ alkoxy, C₁-C₄ alkylamino, and C₁-C₄ alkyl, although at most two of Z₇, Z₈ and Z₉ can be C₁-C₄ alkyl and where R is C₁-C₄ alkyl.

20. The chromatographic material of claim 1, wherein the zwitterionic polymer further comprises weak cation exchange groups or weak anion exchange groups.

21. The chromatographic material of claim 20, the weak cation exchange groups comprise carboxyl groups and the weak anion exchange groups comprise primary, secondary or tertiary amine groups.

22. (canceled)

23. (canceled)

24. (canceled)

25. (canceled)

26. (canceled)

27. (canceled)

28. (canceled)
